(19) United States
(12) Patent Application Publication
(10) Pub. No.: US 2022/0275245 A1
(43) Pub. Date: Sep. 1, 2022

(54) METHOD FOR PRODUCING HIGH FUNCTIONAL ORGANIC/INORGANIC HYBRID COATING AGENT

(71) Applicant: Changwon National University Industry University Cooperation Foundation, Changwon-si (KR)

(72) Inventors: Yeon Gil JUNG, Changwon-si (KR); Jeong Hun SON, Gimhae-si (KR); Yeon Bin CHOI, Changwon-si (KR); Bong Gu KIM, Gimhae-si (KR)

(21) Appl. No.: 17/663,127

(22) Filed: May 12, 2022

Related U.S. Application Data
(63) Continuation of application No. PCT/KR2020/001666, filed on Feb. 5, 2020.

(30) Foreign Application Priority Data
Nov. 26, 2019 (KR) 10-2019-0153477

(51) Int. Cl. C09D 183/06; C08G 77/18; C08G 77/08; C08K 3/38; C08K 3/22; C08K 3/08; C08K 3/04; C09D 7/61; C09D 7/45; C09D 7/20

(52) U.S. Cl. CPC C09D 183/06; C08G 77/18; C08G 77/08; C08K 3/38; C08K 3/22; C08K 3/08; C08K 3/041; C08K 3/042; C08K 3/046; C09D 7/61; C09D 7/45; C09D 7/20; C08K 2201/011; C08K 2003/2227; C08K 2003/385

(57) ABSTRACT

This application relates to a method of preparing an organic/inorganic hybrid coating agent. In one aspect, the method includes adding 15 wt % to 25 wt % of colloidal silica and 1 wt % to 10 wt % of hexagonal boron nitride (h-BN) to a solvent and stirring to obtain a primary solution. The method may also include adding a catalyst and 15 wt % to 35 wt % of silane to the primary solution obtained and stirring to obtain a secondary solution, and adding 10 wt % to 30 wt % of a dispersant and a functional powder to the secondary solution.

### CROSS-REFERENCE TO RELATED APPLICATIONS

This application is a continuation application, and claims the benefit under 35 U.S.C. § 120 and § 365 of PCT Application No. PCT/KR2020/001666 Filed on Feb. 5, 2020, which claims priority to Korean Patent Application No. 10-2019-0153477 Filed on Nov. 26, 2019, the contents of each of which are hereby incorporated by reference in their entirety.

### BACKGROUND

### Technical Field

The present disclosure has resulted from study and research conducted by Changwon University (in Korea) under the following national R&D projects (i), (ii), and (iii) supported by Korean Government Agencies: (1) a national R&D project supported by the Ministry of Trade, Industry, and Energy (project number: 1415163387, project name: development of human resources for energy-related technology, research project name: combined research on efficiency improvement of high-temperature parts of gas turbines and advanced human resource training track, research management institution: Korea Institute of Industrial Technology Evaluation and Planning, organized by: Changwon University Industry-University Cooperation Foundation, research period: 2019 Jan. 1 to 2021 Dec. 31; (ii) a national R&D project supported by the Ministry of Science, ICT and Future Planning (project number: 1711091370, project name: leading research center support project, research project name: mechatronics combined parts and materials research center, research management institution: and a national R&D project supported by the Ministry of Trade, Industry, and Energy (Project number: 1415163444, project name: development of energy demand management core technology (Eteuk) (R&D), research project name: technology development for manufacturing and commercialization of 3D printing-based ceramic core for 450 mm impeller with 4 mm flow path, research management institution: Korea Institute of Industrial Technology Evaluation and Planning, organized by: Jinsung Precision Metal Co., Ltd, and research period: 2017 May 1 to 2019 Dec. 31).

### Description of Related Technology

Recently, research and development of organic/inorganic hybrid materials using advantages of inorganic materials excellent in mechanical properties, heat resistance, and stability and advantages of organic materials excellent in light weight, ductility, elasticity, and moldability are being actively conducted. The organic/inorganic hybrid materials can be widely used in various applications in electrical and electronic industry, chemistry industry, and aviation industry.

### SUMMARY

The present disclosure provides a method of preparing a high functional organic/inorganic hybrid coating agent having advantages of organic materials, such as flexibility and lightness, and advantages of inorganic materials, such as abrasion resistance, insulation, high-temperature thermal resistance, high hardness, and chemical resistance, being capable of controlling hydrophilicity or hydrophobicity, and being cured at room temperature without requiring a heat treatment process when forming a coating layer.

In order to achieve the above technical objective, the present disclosure proposes a method of preparing an organic/inorganic hybrid coating agent (see FIG. 1), the method including: (a) adding 15 to 25 wt % of colloidal silica and 1 to wt % of hexagonal boron nitride (h-BN) to a solvent and stirring to obtain a primary solution; (b) adding a catalyst and 15 to 35 wt % of silane to the primary solution obtained in step (a) and stirring to obtain a secondary solution; and (c) adding 10 to 30 wt % of a dispersant and a functional powder to the secondary solution obtained in step (b).

In addition, in the method of preparing the organic/inorganic hybrid coating agent, the solvent may be at least one solvent selected from ethanol, methanol, hexane, and isopropyl alcohol.

In addition, in the method of preparing the organic/inorganic hybrid coating agent, the catalyst may be hydrochloric acid, sulfuric acid, nitric acid, ammonia, acetic acid, or potassium hydroxide.

In addition, in the method of preparing the organic/inorganic hybrid coating agent, the silane may be at least selected from methyltriethoxysilane (MTES), methyltrimethoxysilane (MTMS), ethyltrimethoxysilane (ETMS), octadecyltrimethoxysilane (OTMS), ethyltriethoxysilane (ETES), and 3-glycidoxypropyltrimethoxysilane (GPTMS).

In addition, in the method of preparing the organic/inorganic hybrid coating agent, the functional powder may be made of a ceramic, metal, or carbon-based nano material.

In addition, in the method of preparing the organic/inorganic hybrid coating agent, the ceramic may be (i) an oxide-based ceramic or (ii) a non-oxide-based ceramic selected from nitride, carbide, boride, and silicide.

In addition, in the method of preparing the organic/inorganic hybrid coating agent, the ceramic may be at least one selected from ZrO₂, Al₂O₃, SiO₂, CeO₂, TiO₂, SiC, Si₃N₄, and glass beads.

In addition, in the method of preparing the organic/inorganic hybrid coating agent, the metal may be at least one metal or an alloy of two or more metals selected from the group consisting of Al, Cu, Ti, Mg, K, Ca, Sc, V, Cr, Mn, Fe, Co, Ni, Zn, Ga, Rb, Sr, Y, Zr, Mo, Ru, Rh, Pd, Ag, Cd, In, Sn, Cs, Ba, La, Ce, Nd, Sm, Eu, Gd, Tb, W, Cd, Sn, Hf, Ir, Pt, and Pb.

In addition, in the method of preparing the organic/inorganic hybrid coating agent, the carbon-based nanomaterial may be carbon nanotubes, carbon nanofibers, carbon nanoparticles, mesoporous carbon, carbon nanosheets, carbon nanorods, or carbon nanobelts.

In addition, in the method of preparing the organic/inorganic hybrid coating agent, in step (c), the addition of the dispersant may be performed prior to the addition of the functional powder.

In another aspect of the present disclosure, there is provided an organic/inorganic hybrid coating agent prepared by the method described above.

The organic/inorganic hybrid coating agent prepared by the preparation method of the present disclosure can be applied to various base members such as metal, ceramic, plastic, paper, fabric, and glass fiber by dip coating, brush coating, spray coating, spin coating, etc. The organic/inorganic hybrid coating agent is a room temperature self-curing organic/inorganic hybrid coating agent that does not require a heat treatment process for curing when a coating layer is formed therefrom. Depending on the functional powder (for example, metal, ceramic, etc.) added to prepare the organic/inorganic hybrid coating agent, the coating agent not only implements the primary purpose thereof (i.e., protection of a base member) but also improves various characteristics of the base member, such as heat dissipation, heat resistance, abrasion resistance, insulation, antibacterial function, chemical resistance, corrosion resistance, adhesion, magnetic properties, surface roughness, contact angle, and color.

### BRIEF DESCRIPTION OF THE DRAWINGS

FIG. 1 is a process flowchart illustrating a method of preparing an organic/inorganic hybrid coating agent according to the present disclosure.

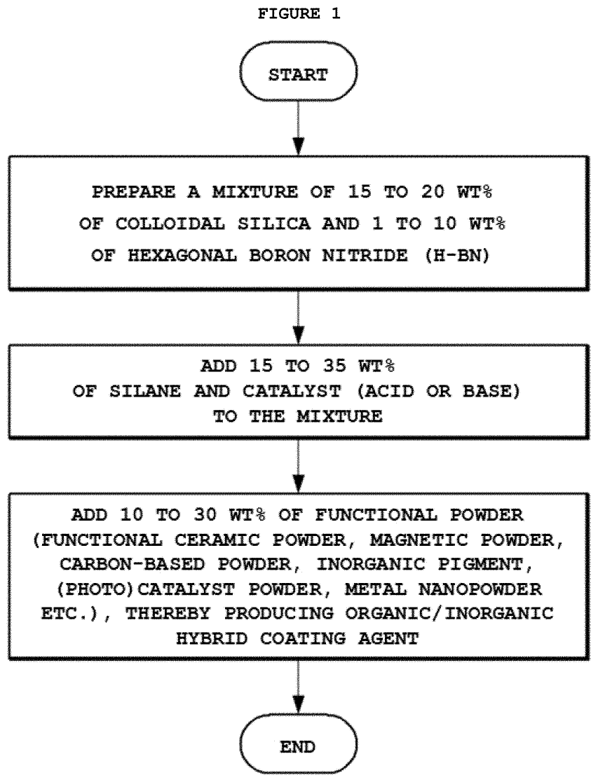

FIG. 2 is a process flowchart illustrating a method of preparing an organic/inorganic hybrid coating agent containing a functional powder step by step.

FIG. 3 is FE-SEM images of coating layers formed using organic/inorganic hybrid coating agents containing different amounts of colloid silica (Si sol) in Example 1 of the present application.

FIG. 4 is FE-SEM images of coating layers formed using organic/inorganic hybrid coating agents with and without h-BN in Example 2 of the present application.

FIG. 5 is FE-SEM images of coating layers formed using organic/inorganic hybrid coating agents containing different amounts of Silane in Example 3 of the present application.

FIG. 6 is a measurement result of adhesion and pencil hardness of a coating layer formed using an organic/inorganic hybrid coating agent containing Al₂O₃ as the functional powder in Example 4 of the present application.

### DETAILED DESCRIPTION

When an organic/inorganic hybrid material is used as a material for forming various coating layers, the coating layer not only performs the fundamental function of protecting a base member thereunder but also exhibits auxiliary advantageous functions such as heat resistance, abrasion resistance, corrosion resistance, antibacterial properties, insulation, high adhesion, aesthetics (color), bendability (flexibility). Therefore, interest and research on coatings made of organic/inorganic hybrid materials are increasing.

In describing the present disclosure, well-known functions or constructions will not be described in detail when it is determined that they may obscure the gist of the present disclosure.

Since embodiments in accordance with the concept of the present disclosure can undergo various changes and have various forms, only some specific embodiments are illustrated in the drawings and described in detail in the present specification. While specific embodiments of the present disclosure are described herein below, they are only for illustrative purposes and should not be construed as limiting to the present disclosure. Thus, the present disclosure should be construed to cover not only the specific embodiments but also cover all modifications, equivalents, and substitutions that fall within the concept and technical spirit of the present disclosure. The terminology used herein is for the purpose of describing particular embodiments only and is not intended to limit the scope of the present disclosure. As used herein, the singular forms “a”, “an”, and “the” are intended to include the plural foams as well unless the context clearly indicates otherwise. It will be further understood that the terms “comprise” or “has” when used in the present specification specify the presence of stated features, regions, integers, steps, operations, elements and/or components, but do not preclude the presence or addition of one or more other features, regions, integers, steps, operations, elements, components and/or combinations thereof.

Hereinafter, the embodiments of the present disclosure will be described in more detail by way of examples.

Examples disclosed in the present disclosure can be modified into various other forms, and the scope of the present disclosure is not construed as being limited to the examples described below. Examples are provided to more fully describe the present disclosure to the ordinarily skilled in the art.

### EXAMPLE

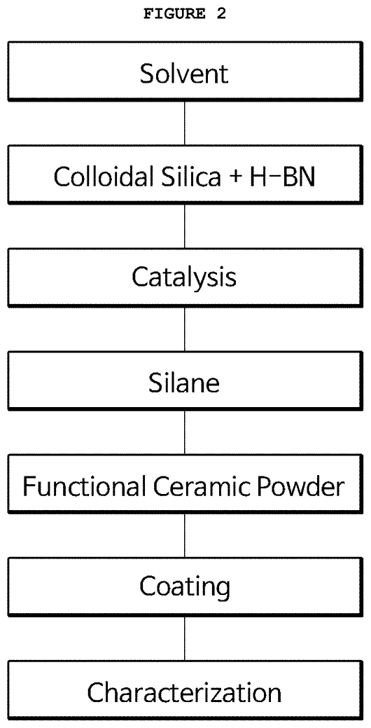

A method of preparing an organic/inorganic hybrid coating agent in this example is schematically shown in FIG. 2.

First, 15 to 25 wt % of colloidal silica and 1 to 10 wt % of h-BN were added to one or more solvents (ethanol, methanol, hexane, isopropyl alcohol, etc.) and sufficiently stirred at 200 to 1000 rpm for 1 hour. After the stirring, one or more substances among hydrochloric acid, sulfuric acid, nitric acid, ammonia, acetic acid, or KOH were added are added as a catalyst, and the 15 to 35 wt % of one or more compounds selected from methyltriethoxysilane (MTES), methyltrimethoxysilane (MTMS), ethyltrimethoxysilane (ETMS), octadecyltrimethoxysilane (OTMS), ethyltriethoxysilane (ETES), and 3-glycidoxypropyltrimethoxysilane (GPTMS) were added as silane and then sufficiently stirred for 30 minutes or longer. A dispersant was then added to improve dispersibility. Next, a functional powder (for example, ZrO₂, Al₂O₃, SiO₂, CeO₂, TiO₂, SiC, Si₃N₄, glass beads, magnetic powder, carbon-based powder, or potassium titanate whisker (PTW)), an inorganic pigment, (photo)catalyst powder, and metal nanopowder (for example, Ag, Ni, Co, Pt, Pd, Cu, Au, Mn, Cr, etc.) were added in an amount of 10 to 30 wt % and sufficiently stirred for 1 hour or longer, thereby producing an organic/inorganic hybrid coating agent.

With the use of the coating agent, coating films were formed on various specimens. The surface roughness of each of the prepared coating film was evaluated using a surface roughness meter (SJ-310), and the coating thickness and the microstructure of each of the coating films were evaluated using a field emission scanning electron microscope (FE-SEM, CZ/MIRA I LMH, TESCA). The hardness and adhesion characteristics of the coating films were evaluated through a pencil hardness test (ASTM D 3363) and an adhesion test (ASTM D3359-02). The flexibility characteristics of the coating films were evaluated through a bending test using a universal tensile tester.

### Example 1

An organic/inorganic hybrid coating agent was prepared and applied on a specimen by controlling the content of Si sol (colloid silica) in the range of 15 to 25 wt %.

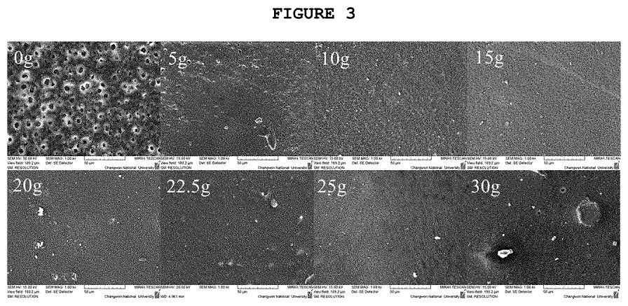

FIG. 3 is an FE-SEM result for evaluating the surface microstructure of a coating film prepared by coating a specimen with an organic/inorganic hybrid coating agent prepared by varying the addition amount of colloid silica (Si sol) in the range of 0 to 30 g. In the case of the specimen to which colloid silica (Si sol) was not added, the surface was not even and a considerable number of spherical voids were observed. As the amount of colloid silica (Si sol) added increased, the surface became more even and the structure of the film became denser.

### Example 2

An organic/inorganic hybrid coating agent was prepared by controlling the content of h-BN in the range of 1 to 10 wt %.

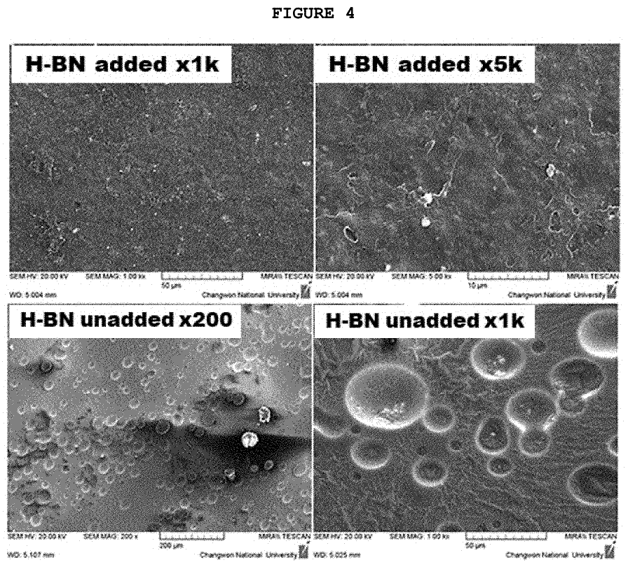

FIG. 4 is E-SEM images of coating layers formed using organic/inorganic hybrid coating agents prepared by adding or not adding h-BN. In the case of a specimen on which a coating layer formed from a coating agent not containing h-BN, the surface of the coating layer was not even and the hemispherical surface was observed. As the content of h-BN increased, the coating layer became more even and denser, and it was confirmed that the adhesion and hardness were improved.

### Example 3

Organic/inorganic hybrid coating agents were prepared by varying the content of one silane or two or more silanes selected from the group consisting of methyltriethoxysilane (MTES), methyltrimethoxysilane (MTMS), ethyltrimethoxysilane (ETMS), octadecyltrimethoxysilane (OTMS), ethyltriethoxysilane (ETES), and 3-glycidoxypropyltrimethoxysilane (GPTMS) in the range of 15 to 35 wt %.

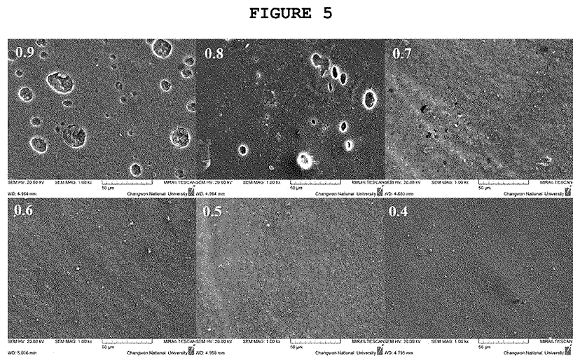

FIG. 5 is FE-SEM images of coating layers formed from organic/inorganic hybrid coating agents that are differ in the content of silane added in Example 3 of the present application. In the case of the specimen in which the weight ratio of silane to colloid silica (Si sol) was 1:0.7 to 1:0.9, spherical empty voids were observed on the surface of the formed thin film formed thereon. When the weight ratio of silane to silica was 1:0.6 or less, it was observed that a film with an even surface and a dense structure was formed. In addition, the prepared coating agents exhibited different viscosities depending on the type and ratio of the added silane. Regarding the adhesion, the films were confirmed to have excellent adhesion to the extent of 5B depending on the conditions.

### Example 4

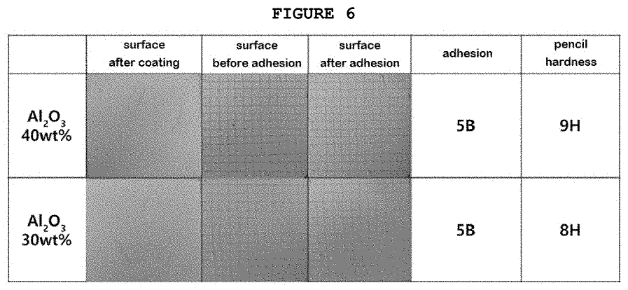

In order for organic/inorganic hybrid coating agents to exhibit additional beneficial characteristics aside from the primary purpose (i.e., base member protection) thereof, various functional powders (for example, metal, ceramic, etc.) were added in an amount in the range of 10 to 30 wt % to prepare organic/inorganic hybrid coating agents. The prepared coating agents differed in viscosity depending on the type and particle size of the added powder. For example, referring to FIG. 6 showing the adhesion and pencil hardness measurement results of the coating layers formed using the organic/inorganic hybrid coating agent prepared by adding Al₂O₃ as a functional powder, the maximum adhesion was 5B, and the maximum pencil hardness was 9H. That is, it was confirmed that the coating film exhibited excellent properties.

### Example 5

A coating film was formed through dip coating, brush coating, spray coating, or spin coating using the prepared organic/inorganic hybrid coating agent. When forming the coating film, to control the thickness of the coating film, the application of the coating agent was performed 1 to 10 times. Depending on the viscosity of the organic/inorganic coating agent, and the number of applications of the organic/inorganic coating agent, and the coating method, it was possible to produce coating films with various thicknesses in the range of 1 to several hundreds of micrometers, and the prepared coating films also varied in film thicknesses such as the surface roughness (Ra: 0.3 to 1.0 μm) and adhesion (5B at maximum).

The organic/inorganic hybrid coating agent prepared by the preparation method of the present disclosure can be applied to various base members such as metal, ceramic, plastic, paper, fabric, and glass fiber by dip coating, brush coating, spray coating, spin coating, etc. The organic/inorganic hybrid coating agent is a room temperature self-curing organic/inorganic hybrid coating agent that does not require a heat treatment process for curing when a coating layer is formed therefrom. Depending on the functional powder (for example, metal, ceramic, etc.) added to prepare the organic/inorganic hybrid coating agent, the coating agent not only implements the primary purpose thereof (i.e., protection of a base member) but also improves various characteristics of the base member, such as heat dissipation, heat resistance, abrasion resistance, insulation, antibacterial function, chemical resistance, corrosion resistance, adhesion, magnetic properties, surface roughness, contact angle, and color.

While exemplary embodiments of the present disclosure have been described with reference to the accompanying drawings, those skilled in the art will appreciate that the present disclosure can be implemented in other different forms without departing from the technical spirit or essential characteristics of the present disclosure. Therefore, it can be understood that the examples described above are only for illustrative purposes and are not restrictive in all aspects.

The organic/inorganic hybrid coating agent prepared by the preparation method of the present disclosure is a room temperature self-curing organic/inorganic hybrid coating agent that does not require a heat treatment process for curing when a coating layer is formed therefrom. The coating agent can be suitably used to form a coating layer on a base member such as metal, ceramic, plastic, paper, fabric, glass fiber, etc. ex, metal, ceramics, etc. through dip coating, brush coating, spray coating, spin coating, etc., whereby the coating layer not only functions to protect the base member but also imparts various characteristics on various base members such as heat dissipation, heat resistance, abrasion resistance, insulation, antibacterial, chemical resistance, corrosion resistance, adhesion, magnetic properties, surface roughness, contact angle, and color to the base member.

What is claimed is:

1. A method of preparing an organic/inorganic hybrid coating agent, the method comprising:
adding 15 wt % to 25 wt % of colloidal silica and 1 wt % to wt % of hexagonal boron nitride (h-BN) to a solvent and stirring to obtain a primary solution;
adding a catalyst and 15 wt % to 35 wt % of silane to the primary solution and stirring to obtain a secondary solution; and
adding 10 wt % to 30 wt % of a dispersant and a functional powder to the secondary solution.

2. The method of claim 1, wherein the solvent is at least one of ethanol, methanol, hexane, or isopropyl alcohol.

3. The method of claim 1, wherein the catalyst is hydrochloric acid, sulfuric acid, nitric acid, ammonia, acetic acid, or potassium hydroxide.

4. The method of claim 1, wherein the silane is at least one of methyltriethoxysilane (MTES), methyltrimethoxysilane (MTMS), ethyltrimethoxysilane (ETMS), octadecyltrimethoxysilane (OTMS), ethyltriethoxysilane (ETES), or 3-glycidoxypropyltrimethoxysilane (GPTMS).

5. The method of claim 1, wherein the functional powder is made of a ceramic, metal, or carbon-based nano material.

6. The method of claim 5, wherein the ceramic is (i) an oxide-based ceramic or (ii) a non-oxide-based ceramic selected from nitride, carbide, boride, or silicide.

7. The method of claim 5, wherein the metal is at least one metal or an alloy of two or more metals selected from the group consisting of Al, Cu, Ti, Mg, K, Ca, Sc, V, Cr, Mn, Fe, Co, Ni, Zn, Ga, Rb, Sr, Y, Zr, Mo, Ru, Rh, Pd, Ag, Cd, In, Sn, Cs, Ba, La, Ce, Nd, Sm, Eu, Gd, Tb, W, Cd, Sn, Hf, Ir, Pt, and Pb.

8. The method of claim 5, wherein the carbon-based nanomaterial is carbon nanotubes, carbon nanofibers, carbon nanoparticles, mesoporous carbon, carbon nanosheets, carbon nanorods, or carbon nanobelts.

9. The method of claim 1, wherein the addition of the dispersant is performed prior to the addition of the functional powder.

10. An organic/inorganic hybrid coating agent prepared by the method of claim 1.
